(19) United States
(12) Patent Application Publication
(10) Pub. No.: US 2014/0292673 A1
(43) Pub. Date: Oct. 2, 2014

(54) OPERATING SYSTEM AND OPERATIING METHOD THEREOF

(71) Applicant: Acer Incorporated, New Taipei City (TW)

(72) Inventors: Meng-Shih Tsai, New Taipei City (TW); Chueh-Pin Ko, New Taipei City (TW)

(73) Assignee: Acer Incorporated, New Taipei City (TW)

(21) Appl. No.: 13/965,195

(22) Filed: Aug. 13, 2013

(30) Foreign Application Priority Data
Mar. 29, 2013 (TW) 102111457

(51) Int. Cl. G06F 3/041

(52) U.S. Cl. CPC G06F 3/041
USPC 345/173

(57) ABSTRACT

An operating system and an operating method thereof are provided. An auxiliary light from an auxiliary light unit is irradiated to coordinate patterns on a display unit of an electronic apparatus, and the coordinate patterns are invisible to naked eyes. The coordinate patterns are converted to corresponding coordinate position information, and the coordinate position information is transmitted to the electronic apparatus.

### CROSS-REFERENCE TO RELATED APPLICATION

This application claims the priority benefit of Taiwan application serial no. 102111457, filed on Mar. 29, 2013. The entirety of the above-mentioned patent application is hereby incorporated by reference herein and made a part of this specification.

### BACKGROUND OF THE INVENTION

1. Field of Invention

The invention relates to an operating system and an operating method thereof, and particularly to an operating system operated with an auxiliary light and an operating method of the operating system.

2. Description of Related Art

A conventional display panel has functions of displaying information from a system or displaying output signals, and another input apparatus provides input signals to the system. For instance, a touch panel that receives user inputs through the touch action of the user combines the output and input functions and allows the user to interact with the display or the system which is coupled to the display. A cell phone, a notebook computer, a tablet PC, and other devices can be integrated with the touch panel, so that users are allowed to input data or signals in a diverse manner.

A normal touch panel or a normal touch screen has a variety of different designs, such as a resistive-type design, a surface-wave-type design, a capacitive-type design, and an infrared-type design. No matter which type of the touch panel is, the purpose of the design is to allow the users to input data or signals in a convenient manner. For example, all of the resistive-type touch panel, the surface-wave-type touch panel, the capacitive-type touch panel, and the infrared-type touch panel can be operated by the user's fingers or styluses. Although the existing touch panels provide users with many intuitive operations, there is still room for improvement.

### SUMMARY OF THE INVENTION

The invention provides an operating system and an operating method thereof capable of reducing the volume of an electronic apparatus and ensuring the electronic apparatus to comply with the current trend of slimness and light weight.

An operating system of the invention comprises an electronic apparatus, an input apparatus, and an auxiliary light unit. The electronic apparatus has a display unit, and the display unit has a plurality of coordinate patterns. The coordinate patterns are of an invisible size or made of a material that is invisible to naked eyes, and each of the coordinate patterns indicates a coordinate position on the display unit. The input apparatus detects the coordinate patterns, converts the detected coordinate patterns to corresponding coordinate position information, and transmits the coordinate position information to the electronic apparatus. The auxiliary light unit emits an auxiliary light that is irradiated to the coordinate patterns to aid the input apparatus in detecting the coordinate patterns.

In an embodiment of the invention, the input apparatus comprises a detection unit, a wireless transmission unit, and a processing unit. The detection unit detects the coordinate patterns. The wireless transmission unit transmits data with the electronic apparatus. The processing unit is coupled to the detection unit and the wireless transmission unit, converts the coordinate patterns detected by the detection unit to the coordinate position information, and transmits the coordinate position information to the electronic apparatus via the wireless transmission unit.

In an embodiment of the invention, the auxiliary light unit is disposed on the input apparatus and is coupled to the processing unit. The input apparatus further comprises a state sensing unit which is coupled to the processing unit and detects a state of the input apparatus, and the processing unit further determines whether to enable the auxiliary light unit according to the state of the input apparatus.

In an embodiment of the invention, if the input apparatus is moved or used, the processing unit enables the auxiliary light unit to emit the auxiliary light.

In an embodiment of the invention, the state sensing unit comprises an acceleration sensor, a gyro sensor, a light sensor, a pyroelectric infrared sensor, or a tip pressure sensor.

In an embodiment of the invention, the detection unit comprises a complementary metal oxide semiconductor (CMOS) camera or a charge coupled device (CCD) camera, and the auxiliary light unit comprises an infrared irradiation unit.

In an embodiment of the invention, the display unit comprises a display panel or a touch display panel, and the auxiliary light unit is disposed on a side of the coordinate patterns, below the coordinate patterns, or on a side of a backlight unit of the display unit.

An operating method of the invention is applicable to an input apparatus and an electronic apparatus that has a display unit, and the display unit has a plurality of coordinate patterns. The operating method comprises following steps: emitting an auxiliary light that is irradiated to the coordinate patterns, wherein the coordinate patterns are of an invisible size or made of a material that is invisible to naked eyes; detecting through the input apparatus the coordinate patterns that are irradiated by the auxiliary light, wherein the auxiliary light aids the input apparatus in detecting the coordinate patterns, and each of the coordinate patterns indicates a coordinate position on the display unit; converting the detected coordinate patterns to corresponding coordinate position information; transmitting the coordinate position information to the electronic apparatus.

In an embodiment of the invention, the operating method further comprises following steps: detecting a state of the input apparatus; determining whether the input apparatus is moved or used according to the state of the input apparatus; if the input apparatus is moved or used, emitting the auxiliary light that is irradiated to the coordinate patterns.

In an embodiment of the invention, the auxiliary light comprises infrared light, and steps of detecting the coordinate patterns comprise shooting the coordinate patterns with a CMOS camera or a CCD camera.

In an embodiment of the invention, the coordinate patterns are formed on a surface of or inside the display unit through a process.

Based on the above, in the operating system and the operating method thereof, the coordinate patterns that are invisible to naked eyes are formed on the display unit, and the auxiliary light emitted from the auxiliary light unit is employed to aid the input apparatus in detecting the coordinate patterns, so that the input apparatus can convert the detected coordinate patterns to the corresponding coordinate position information and transmit the coordinate position information to the electronic apparatus to execute relevant operations. Accordingly, it is not necessary to make on the electronic apparatus a hardware architecture required by the conventional touch operation, and the volume of the electronic apparatus can be reduced, thus ensuring the electronic apparatus to comply with the current trend of slimness and light weight.

In order to make the aforementioned and other features and advantages of the invention comprehensible, embodiments accompanied with figures are described in detail below.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention.

FIG. 1 is a schematic diagram illustrating an operating system according to an embodiment of the invention.

FIG. 2A-FIG. 2D are schematic diagrams illustrating coordinate patterns of a display unit according to embodiments of the invention.

FIG. 3 is a schematic diagram illustrating an operating system according to another embodiment of the invention.

FIG. 4A-FIG. 4C are schematic diagrams illustrating configurations of auxiliary light units according to embodiments of the invention.

FIG. 5 is a schematic flow chart illustrating an operating method of an operating system according to an embodiment of the invention.

FIG. 6 is a schematic flow chart illustrating an operating method of an operating system according to another embodiment of the invention.

### DESCRIPTION OF EMBODIMENTS

Reference will now be made in detail to the embodiments of the invention, examples of which are illustrated in the accompanying drawings. Wherever possible, the same reference numbers are used in the drawings and the description to refer to the same or like parts.

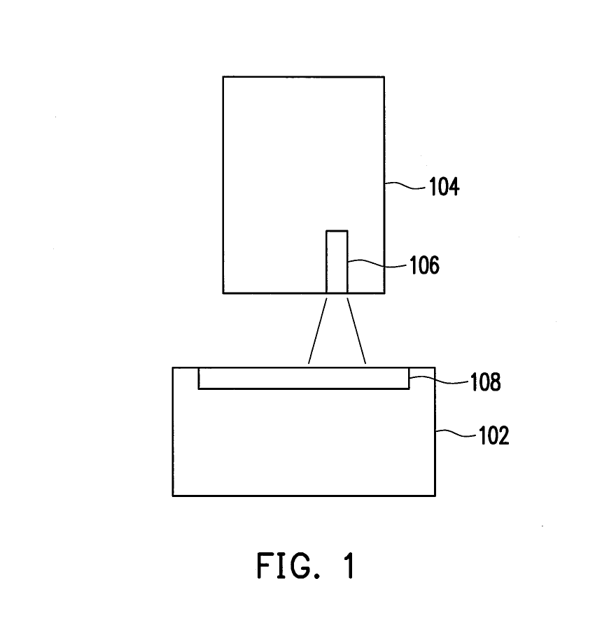

FIG. 1 is a schematic diagram illustrating an operating system according to an embodiment of the invention. Please refer to FIG. 1. The operating system comprises an electronic apparatus 102, an input apparatus 104, and an auxiliary light unit 106. The electronic apparatus 102 may be, for example, an electronic paper display, a TV, a notebook computer, a desktop computer, a touch table, a tablet PC, or a mobile phone. The electronic apparatus 102 comprises a display unit 108. The display unit 108 may be, for example, a display panel or a touch display panel. The display unit 108 has a plurality of coordinate patterns, wherein the coordinate patterns are distributed on the display unit 108 without affecting the display quality of the display unit 108. Each of the coordinate patterns has different geometric shape, so that each of the coordinate patterns may be used to indicate the coordinate position on the display unit 108. The coordinate patterns are of an invisible size or made of a material that is invisible to naked eyes, and the coordinate patterns are formed on the surface of or inside the display unit 108 through a process. The coordinate patterns may be made through printing, etching, press molding, and so on, which should not be construed as limitations to the invention. The material of the coordinate patterns may be indium tin oxide (ITO) or metal, which should not be construed as a limitation to the invention.

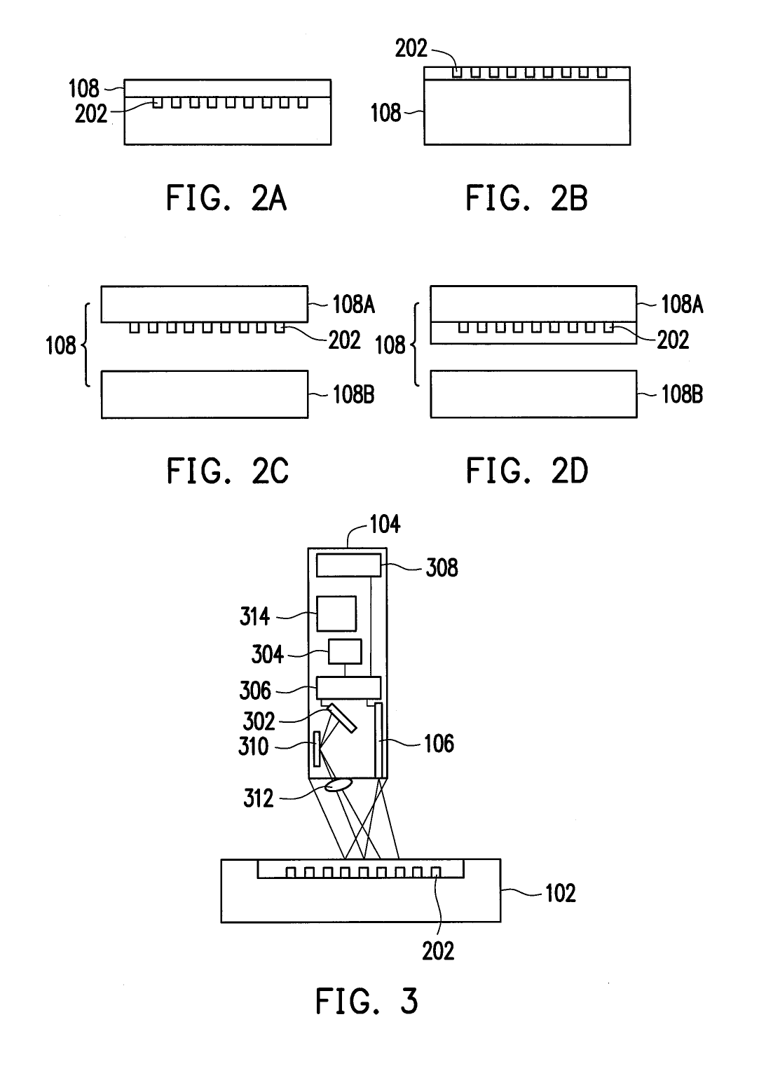

For example, FIG. 2A-FIG. 2D are schematic diagrams illustrating coordinate patterns of a display unit according to embodiments of the invention. In FIG. 2A and FIG. 2B, the display unit 108 is a display panel. As shown in FIG. 2A, the coordinate patterns 202 are formed inside the display panel, and in FIG. 2B, the coordinate patterns 202 are formed on the surface of the display panel. In FIG. 2C and FIG. 2D, the display unit 108 is a touch display panel which may comprise a touch panel 108A and a display panel 108B. In FIG. 2C, the coordinate patterns 202 are formed on the surface of the touch panel 108A, and in FIG. 2D, the coordinate patterns 202 are formed inside the touch panel 108A, such as on a touch layer.

The input apparatus 104 is used to detect the coordinate patterns of the display unit 108, to convert the detected coordinate patterns to corresponding coordinate position information, and to transmit the coordinate position information to the electronic apparatus 102. Thereby, the electronic apparatus 102 may know the coordinate position which corresponds to the coordinate patterns detected by the input apparatus 104, and then the electronic apparatus 102 may perform the corresponding actions, for example, display a cursor on the coordinate position which corresponds to the coordinate patterns, or display a path connected by the coordinate patterns detected by the input apparatus 104. The input apparatus 104 may be, for example, a stylus, a touch ring, a mouse, a remote control, a trackball, a mobile phone, or a tablet PC. The auxiliary light unit 106 is used to emit an auxiliary light that is irradiated to the coordinate patterns on the display unit 108, thus aiding the input apparatus 104 in detecting the coordinate patterns. The auxiliary light unit 106 may be, for example, an infrared irradiation unit or another light irradiation apparatus that may emit light in a different frequency band.

The coordinate patterns are formed on the display unit 108, and the auxiliary light emitted from the auxiliary light unit 106 is employed to aid the input apparatus 104 in detecting the coordinate patterns, such that the input apparatus 104 is able to obtain the coordinate position information that corresponds to the coordinate patterns and transmit the coordinate position information to the electronic apparatus 102, thereby applying it to perform touch operations. Since the coordinate patterns may be of an invisible size or made of a material that is invisible to naked eyes, for example, ITO with transparent properties, the display unit 108 may have better light transmission in comparison with a conventional display panel or a conventional touch display panel, thereby improving the display quality of the display unit. In addition, since a hardware architecture for achieving the touch operation simply needs to be made on the input apparatus 104, the volume of the electronic apparatus 102 may be reduced; as a result, the electronic apparatus 102 is able to comply with the current trend of slimness and light weight.

FIG. 3 is a schematic diagram illustrating an operating system according to another embodiment of the invention. Please refer to FIG. 3. Specifically, the input apparatus 104 may comprise a detection unit 302, a wireless transmission unit 304, a processing unit 306, a state sensing unit 308, a reflecting unit 310, a lens unit 312, and a battery 314. The processing unit 306 is coupled to the auxiliary light unit 106, the detection unit 302, the wireless transmission unit 304, and the state sensing unit 308. Furthermore, the battery 314 is coupled to the auxiliary light unit 106, the detection unit 302, the wireless transmission unit 304, the processing unit 306, and the state sensing unit 308. To make the drawings simple, the coupling relationship of the battery 314 and said devices is not illustrated herein.

The detection unit 302, such as a CMOS camera or a CCD camera, is used to detect the coordinate patterns 202. The wireless transmission unit 304 is used to transmit data with the electronic apparatus 102. The processing unit 306 converts the coordinate patterns 202 detected by the detection unit 302 to the coordinate position information and transmits the coordinate position information to the electronic apparatus 102 via the wireless transmission unit 304, so as to perform relevant touch operations. The functions of the auxiliary light unit 106 have been described in the aforementioned embodiments and are thus not reiterated herein. Furthermore, the state sensing unit 308 is used to detect the state of the input apparatus 104. The reflecting unit 310 may reduce unnecessary optical path designs. The lens unit 312 is used to gather rays of the reflected auxiliary light. The processing unit 306 may determine whether to enable the auxiliary light unit 106 according to the state of the input apparatus 104, so as to prevent the auxiliary light unit 106 from emitting the auxiliary light when the input apparatus 106 does not detect the coordinate patterns and avoids unnecessary power waste. The processing unit 306 may be, for example, formed on a printed circuit board.

The state sensing unit 308 may be, for example, an acceleration sensor, a gyro sensor, a light sensor, a pyroelectric infrared sensor, a tip pressure sensor, or any other sensing unit which may sense that the input apparatus 104 is moved, lifted up, or used. For example, if the state sensing unit 308 is the tip pressure sensor, the processing unit 306 may control the auxiliary light unit 106 to emit the auxiliary light only when the tip of the input apparatus 104 (assumed to be a stylus) senses the pressure. Furthermore, for example, if the state sensing unit 308 is the acceleration sensor or the gyro sensor, the processing unit 306 may control the auxiliary light unit 106 to emit the auxiliary light only when the state sensing unit 308 detects that the input apparatus 104 is moved. Moreover, for example, if the state sensing unit 308 is the light sensor or the pyroelectric infrared sensor, the processing unit 306 may control the auxiliary light unit 106 to emit the auxiliary light only when the state sensing unit 308 detects that the display unit of the electronic apparatus 102 emits light. In addition, the battery 314 is to provide power supply required for operating the auxiliary light unit 106, the detection unit 302, the wireless transmission unit 304, the processing unit 306, and the state sensing unit 308.

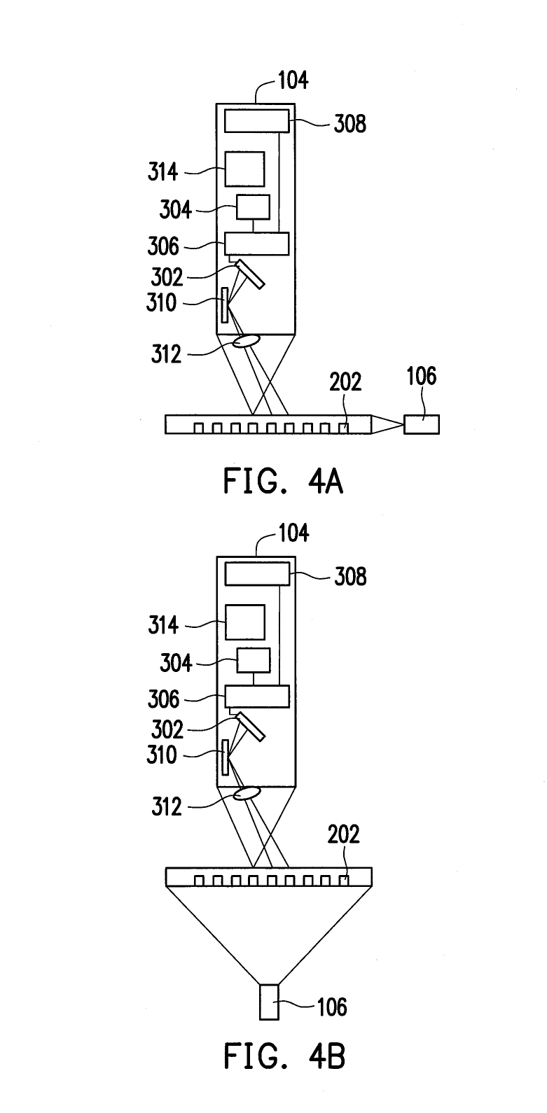

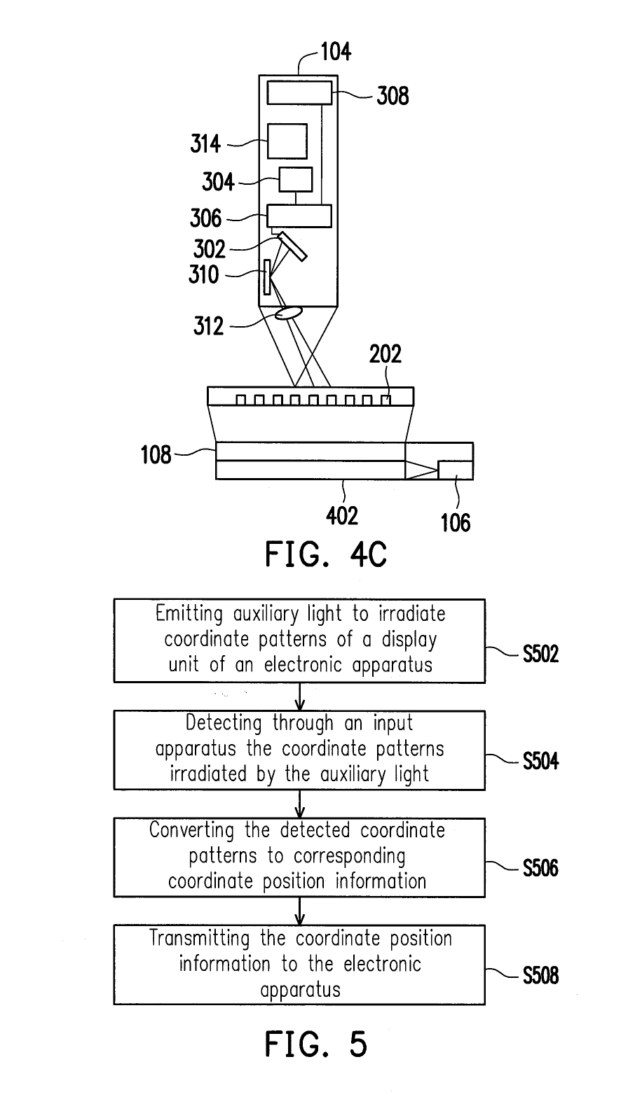

It should be mentioned that the auxiliary light unit 106 described in the previous embodiments is disposed on the input apparatus 104; however, the auxiliary light unit 106 is not limited to that described above and may be disposed at any location that can help the input apparatus 104 detect the coordinate patterns 202. For example, FIG. 4A-FIG. 4C are schematic diagrams illustrating configurations of the auxiliary light units according to the embodiments of the invention. Please refer to FIG. 4A-FIG. 4C. In FIG. 4A, the auxiliary light unit 106 is disposed on a side of coordinate patterns 202. In FIG. 4B, the auxiliary light unit 106 is disposed below the coordinate patterns 202. In FIG. 4C, the auxiliary light unit 106 is disposed on a side of a backlight unit 402 of the display unit 108.

FIG. 5 is a schematic flow chart illustrating an operating method of an operating system according to an embodiment of the invention. Please refer to FIG. 5. The operating method of the aforementioned operating system may include following steps. The auxiliary light is emitted to irradiate the coordinate patterns of the display unit of the electronic apparatus (step S502), wherein the coordinate patterns are of an invisible size or made of a material that is invisible to naked eyes. The auxiliary light may be, for example, infrared light. Furthermore, the coordinate patterns may be detected by shooting the coordinate patterns with a CMOS camera or a CCD camera, for instance. The input apparatus is applied to detect the coordinate patterns that are irradiated by the auxiliary light (step S504), wherein the auxiliary light aids the input apparatus in detecting the coordinate patterns, and each of the coordinate patterns indicates a coordinate position on the display unit. The detected coordinate patterns are converted to the corresponding coordinate position information (step S506), and the coordinate position information is transmitted to the electronic apparatus (step S508), so that the electronic apparatus can perform relevant operations.

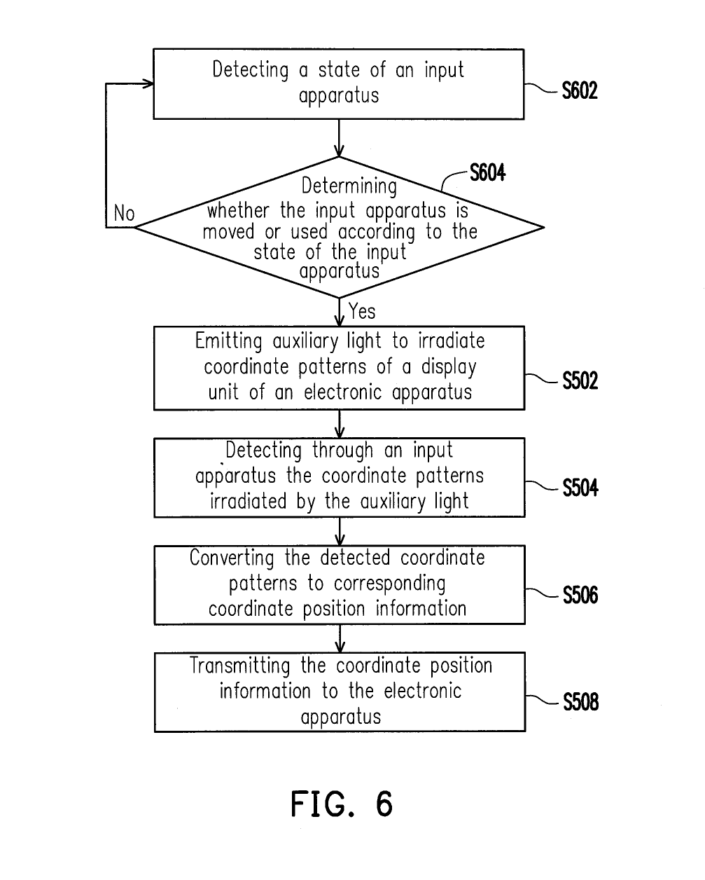

FIG. 6 is a schematic flow chart illustrating an operating method of an operating system according to another embodiment of the invention. Please refer to FIG. 6. The operating method of the operating system described in the present embodiment differs from the embodiment shown FIG. 5 in that the state of the input apparatus described herein is detected in advance (step S602), and whether the input apparatus is moved or used is determined according to the state of the input apparatus (step S604). If the input apparatus is not moved or used, then keep detecting the state of the input apparatus; if the input apparatus is moved or used, then enter step S502 in which the auxiliary light is emitted to irradiate the coordinate patterns of the display unit of the electronic apparatus. This may prevent the auxiliary light unit 106 from emitting the auxiliary light when the input apparatus 106 does not detect the coordinate patterns and avoid unnecessary power waste.

To sum up, in an embodiment of the invention, the coordinate patterns formed on the display unit are of an invisible size or made of a material that is invisible to naked eyes, and the auxiliary light emitted by the auxiliary light unit is utilized to aid the input apparatus in detecting the coordinate patterns, so that the input apparatus can convert the detected coordinate patterns to the corresponding coordinate position information and transmit the coordinate position information to the electronic apparatus to perform relevant operations. Thereby, the volume of the electronic apparatus can be reduced, and the electronic apparatus is able to comply with the current trend of slimness and light weight. Furthermore, the display unit can have better light transmission in comparison with a conventional display panel or a conventional touch display panel, and thus the display unit described herein has favorable display quality. Moreover, in some embodiments of the invention, whether the auxiliary light unit is enabled to emit the auxiliary light is determined according to the detection result of the state sensing unit, which further avoids unnecessary power waste.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. An operating system comprising:
an electronic apparatus having a display unit, the display unit having a plurality of coordinate patterns, wherein the coordinate patterns are of an invisible size or made of a material invisible to naked eyes, and each of the coordinate patterns indicates a coordinate position on the display unit;
an input apparatus detecting the coordinate patterns, converting the detected coordinate patterns to corresponding coordinate position information, and transmitting the coordinate position information to the electronic apparatus; and
an auxiliary light unit emitting an auxiliary light that is irradiated to the coordinate patterns to aid the input apparatus in detecting the coordinate patterns.

2. The operating system as claimed in claim 1, wherein the input apparatus comprises:
a detection unit detecting the coordinate patterns;
a wireless transmission unit transmitting data with the electronic apparatus; and
a processing unit coupled to the detection unit and the wireless transmission unit, the processing unit converting the coordinate patterns detected by the detection unit to the coordinate position information and transmitting the coordinate position information to the electronic apparatus via the wireless transmission unit.

3. The operating system as claimed in claim 2, wherein the auxiliary light unit is disposed on the input apparatus and is coupled to the processing unit, the input apparatus further comprises a state sensing unit coupled to the processing unit, the state sensing unit detects a state of the input apparatus, and the processing unit further determines whether to enable the auxiliary light unit according to the state of the input apparatus.

4. The operating system as claimed in claim 3, wherein if the input apparatus is moved or used, the processing unit enables the auxiliary light unit to emit the auxiliary light.

5. The operating system as claimed in claim 3, wherein the state sensing unit comprises an acceleration sensor, a gyro sensor, a light sensor, a pyroelectric infrared sensor, or a tip pressure sensor.

6. The operating system as claimed in claim 2, wherein the detection unit comprises a complementary metal oxide semiconductor camera or a charge coupled device camera, and the auxiliary light unit comprises an infrared irradiation unit.

7. The operating system as claimed in claim 1, wherein the display unit comprises a display panel or a touch display panel, and the auxiliary light unit is disposed on a side of the coordinate patterns, below the coordinate patterns, or on a side of a backlight unit of the display unit.

8. The operating system as claimed in claim 1, wherein the display unit comprises a display panel or a touch display panel, and the coordinate patterns are formed on a surface of or inside the display unit through a process.

9. An operating method suitable for an input apparatus and an electronic apparatus having a display unit, wherein the display unit has a plurality of coordinate patterns, and the operating method comprises:
emitting an auxiliary light that is irradiated to the coordinate patterns, wherein the coordinate patterns are of an invisible size or made of a material that is invisible to naked eyes;
detecting through the input apparatus the coordinate patterns that are irradiated by the auxiliary light, wherein the auxiliary light aids the input apparatus in detecting the coordinate patterns, and each of the coordinate patterns indicates a coordinate position on the display unit;
converting the detected coordinate patterns to corresponding coordinate position information; and
transmitting the coordinate position information to the electronic apparatus.

10. The operating method as claimed in claim 9, further comprising:
detecting a state of the input apparatus;
determining whether the input apparatus is moved or used according to the state of the input apparatus; and
if the input apparatus is moved or used, emitting the auxiliary light that is irradiated to the coordinate patterns.

11. The operating method as claimed in claim 9, wherein the auxiliary light comprises infrared light, and the step of detecting the coordinate patterns comprises shooting the coordinate patterns with a complementary metal oxide semiconductor camera or a charge coupled device camera.

12. The operating method as claimed in claim 9, wherein the coordinate patterns are formed on a surface of or inside the display unit through a process.
